(19) United States
(12) Patent Application Publication
(10) Pub. No.: US 2001/0039523 A1
(43) Pub. Date: Nov. 8, 2001

(54) System and method for supporting provision of rating related service

(75) Inventor: Tetsuro Iwamoto, Chiyoda-ku (JP)

Correspondence Address: OLIFF & BERRIDGE, PLC, 277 S. WASHINGTON STREET, SUITE 500, ALEXANDRIA, VA, 22314, US

(73) Assignee: THE TOKIO MARINE AND FIRE INSURANCE CO., LTD

(21) Appl. No.: 09/816,211

(22) Filed: Mar. 26, 2001

(30) Foreign Application Priority Data
Apr. 28, 2000 (JP) 2000-129812

(51) Int. Cl. G06F 17/60

(52) U.S. Cl. 705/35

(57) ABSTRACT

An object of the present invention is to provide technology for clearly expressing effects of the financial measures to improve the rating to the customer company. Financial data estimating unit 3 estimates from present financial data 1, estimated financial data 5 corresponding to financial measures, such as a structured finance. Credit score calculating unit 7 calculates a present credit score from the present financial data 1, and an estimated credit score corresponding to each financial measure from the estimated financial data 5. Bankruptcy probability calculating unit 9 calculates estimated bankruptcy probability after the financial measures selected by selection unit 11 from the estimated financial data 5, and present bankruptcy probability from the present financial data 1. Estimated rating computing unit 13 computes the estimated rating after the financial measures and its probability. Pricing calculating unit 15 calculates a rate for each kind of financial services from the estimated bankruptcy probability. Therefore, it is possible to present an improved degree of the rating and an improved degree of the rate for the financial service by the financial measures.

### TECHNICAL FIELD OF THE INVENTION

The present invention relates to technology for supporting provision of new financial service.

### BACKGROUND OF THE INVENTION

For example, Japanese laid open patent application 05-334309 and 06-168219 disclose technology for computing information about high-precision bond rating by a neuro-computer using the fuzzy theory and for enabling to perform financial consultation. In this application, the financial consultation means a consultation as to how to improve the financial data.

In the above described application, the consultation as to how to improve the financial data is performed to upgrade the bond rating by using a special software (Neural Network). However, there is no consideration about the pricing in various kinds of financial services the company can get if the bond rating is upgraded (if an estimated risk amount is lowered). In addition, there is no link between the financial service accompanying the financial measures(financial action) performed to improve the rating and the improvement of the rating itself. Therefore, motivation for the financial measures to improve the rating is unclear.

### SUMMARY OF THE INVENTION

Therefore, an object of the present invention is to provide technology for clearly expressing effects of the financial measures to improve the rating to the customer company.

In the present invention, information concerning an estimated rating corresponding to the financial state change by the financial measures, such as a structured finance, and information concerning the company credit risk, such as a bankruptcy probability, improved by the financial measures are calculated. As a result, it becomes possible to express to the customer company, the improvement of the rating by the structured finance, for example, and the improvement of a premium rate for the yield guarantee of the bond issued by the structured finance, for example. Therefore, compared to conventional arts, the effects by the proposed financial measures and the motivation for the proposed financial measures become clear to the customer company. The summary of the present invention is as follows.

A system of the first aspect of the present invention for supporting provision of rating related service comprises: means for calculating an estimated rating point value (for example, a credit score in the preferred embodiment) corresponding to a financial state changing measure (for example, financial measures, such as a structured finance) applicable to a particular company by using estimated financial data after the financial state changing measure applicable to the particular company is performed and a predetermined rating point value formula; means for calculating numeral data (for example, data of the bankruptcy probability or a rate in the financial service (for example, a premium rate and etc.)) that corresponds to the estimated rating point value and is associated with a credit risk of the particular company by using the estimated financial data after the financial state changing measure is performed; and means for outputting the estimated rating point value corresponding to the financial state changing measure applicable to the particular company and the numeral data that corresponds to the estimated rating point value and is associated with the credit risk of the particular company.

A system of the second aspect of the present invention for supporting provision of rating related service comprises: means for calculating an estimated rating point value corresponding to a financial state changing measure applicable to a particular company by using estimated financial data after the financial state changing measure applicable to the particular company is performed and a predetermined rating point value formula; means for stochastically estimating a rating (for example, a rating symbol or number, such as BBB and A) from the estimated rating point value; means for calculating numeral data that corresponds to the estimated rating point value and is associated with a credit risk of the particular company by using the estimated financial data after the financial state changing measure is performed; and means for outputting the rating stochastically estimated from the estimated rating point value and the numeral data that corresponds to the estimated rating point value and is associated with the credit risk of the particular company.

The first and second aspects of the present invention may further comprise means for calculating a rating point value corresponding to a present financial state of the particular company by using financial data that represents the present financial state of the particular company and the predetermined rating point value formula. In this case, the aforementioned means for outputting may further output the rating point value corresponding to the present financial state of the particular company and/or an improved point value of the estimated rating point value from the rating point value corresponding to the present financial state. This enable the customer company to easily recognize the improvement of the rating point caused by the financial measures.

It is possible to configure the first aspect of the present invention to further include means for computing an estimated rating (for example, a rating symbol or number such as BBB and A) corresponding to the estimated rating point value and information concerning the probability of the estimated rating. In this case, the aforementioned means for outputting may further output the estimated rating corresponding to the estimated rating point value and the information concerning the probability of the estimated rating.

The first and second aspects of the present invention may further comprise means for calculating numeral data associated with the present credit risk of the particular company by using the financial data that represents the present financial state of the particular company. In this case, the aforementioned means for outputting may further output the numeral data associated with the present credit risk of the particular company and/or an improved degree of the numeral data that corresponds to the estimated rating point value and is associated with the credit risk from the numeral data associated with the present credit risk. This enable the customer company to easily recognize the improved degree of the numeral data concerning the credit risk by the financial measures.

The aforementioned means for calculating the numeral data associated with the estimated credit risk may be configured so as to calculate bankruptcy probability of the particular company by using the estimated financial data after the financial state changing measure is performed and a predetermined bankruptcy probability formula. Data for the bankruptcy probability is a base data in the pricing for the financial service (crediting).

In addition, the aforementioned means for calculating the numeral data associated with the estimated credit risk may be configured so as to calculate numeral data concerning costs of one or a plurality of financial services applicable to the particular company. In this case, the numeral data concerning costs corresponds to the data concerning the bankruptcy probability of the particular company. The costs of the financial services are results of the pricing of the financial services and are calculated by referring to the credit risk of the particular company.

Furthermore, the aforementioned means for calculating the estimated rating point value may be configured so as to calculate estimated rating point values respectively corresponding to a plurality of financial state changing measures applicable to the particular company by using a plurality of estimated financial data after the plurality of financial state changing measures applicable to the particular company are performed and the predetermined rating point value formula. In this case, the aforementioned means for calculating the numeral data associated with the estimated credit risk may be configured so as to calculate numeral data that is associated with the estimated credit risk of the particular company and corresponds to a selected estimated rating point value of the plurality of the estimated rating point values calculated above.

A method of the third aspect of the present invention for supporting provision of rating related service comprises the steps of: calculating an estimated rating point value corresponding to a financial state changing measure applicable to a particular company by using estimated financial data after the financial state changing measure applicable to the particular company is performed and a predetermined rating point value formula; calculating numeral data that corresponds to the estimated rating point value and is associated with a credit risk of the particular company by using the estimated financial data after the financial state changing measure is performed; and outputting the estimated rating point value corresponding to the financial state changing measure applicable to the particular company and the numeral data that corresponds to the estimated rating point value and is associated with the credit risk of the particular company.

A method of the fourth aspect of the present invention for supporting provision of rating related service comprises the steps of: calculating an estimated rating point value corresponding to a financial state changing measure applicable to a particular company by using estimated financial data after the financial state changing measure applicable to the particular company is performed and a predetermined rating point value formula; stochastically estimating a rating from the estimated rating point value; calculating numeral data that corresponds to the estimated rating point value and is associated with a credit risk of the particular company by using the estimated financial data after the financial state changing measure is performed; and outputting the rating stochastically estimated from the estimated rating point value and the numeral data that corresponds to the estimated rating point value and is associated with the credit risk of the particular company.

The variations as to the first and second aspects of the present invention are applicable to the third and fourth aspects of the present invention.

In addition, it is possible to implement programs which cause a computer to execute these methods, and the programs are stored in a storage medium or storage device, such as a floppy disk, a CD-ROM, a magneto-optic disk, a semiconductor memory, a hard disk and etc. and distributed through a network. The intermediate processing result is temporarily stored in a memory, such as main memory.

### BRIEF DESCRIPTION OF THE DRAWINGS

FIG. 1 is a block diagram of a system for supporting provision of rating related service of the embodiment of the present invention;

FIG. 2 is a table, which represents a corresponding example between credit scores and rating symbols;

FIG. 3 is a table, which represents an example of the present financial data;

FIG. 4 is a processing flow of the embodiment of the present invention;

FIG. 5 is a table, which represents an example of the estimated financial data;

FIG. 6 is a table, which represents calculation results of the estimated credit scores corresponding to the financial measures;

FIG. 7 is a table, which represents a result of sorting FIG. 6 by values of the estimated credit scores;

FIG. 8 is a table, which represents a selection result by the selection unit;

FIG. 9 is a graph, which represents an example of distributions of credit scores in each rating;

FIG. 10 is a graph, which represents probability for each rating corresponding to a certain estimated credit score;

FIG. 11 is a table, which represents an example of calculation results by the estimated rating computing unit;

FIG. 12 is a table, which represents an example of calculation results by the bankruptcy probability calculating unit; and

FIG. 13 is a table, which represents an example of calculation results by the pricing calculating unit.

### DETAIL DESCRIPTION OF THE PREFERRED EMBODIMENTS

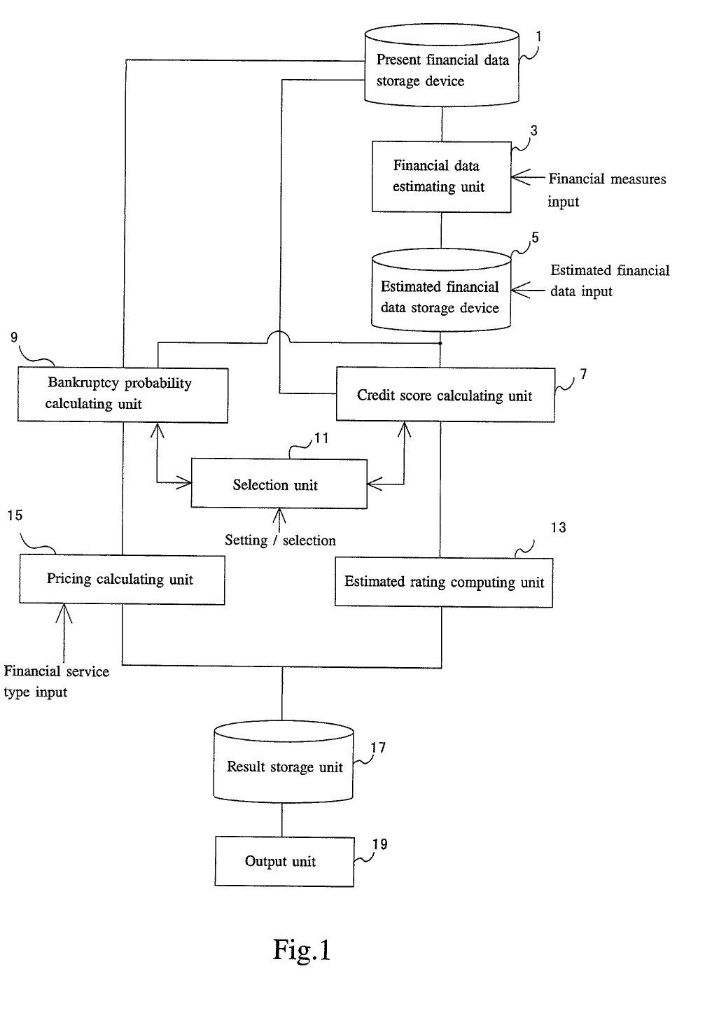

FIG. 1 shows a functional block diagram of a system for supporting provision of rating related service of the preferred embodiment of the present invention. A present financial data storage device 1, which stores present financial data of a company, is referred by a financial data estimating unit 3 for estimating financial data, which changes in correspondence with input financial measures, from the present financial data based on a predetermined rule to generate estimated financial data, a credit score calculating unit 7 for calculating a credit score from the financial data by a predetermined formula, and a bankruptcy probability calculating unit 9 for calculating bankruptcy probability of the company from the financial data by a predetermined formula.

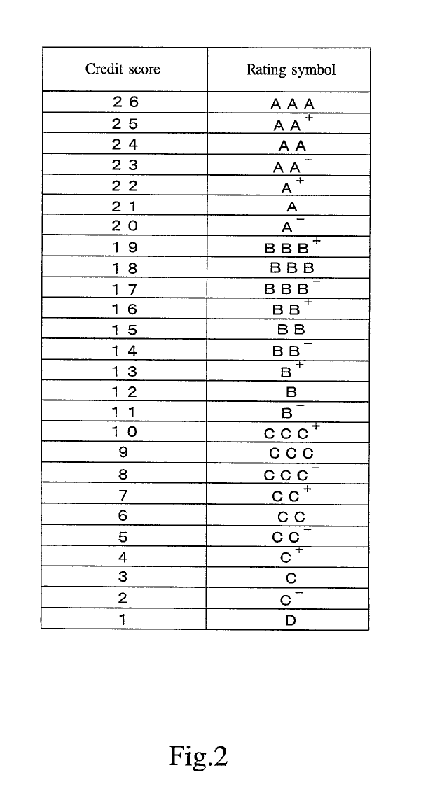

The credit score means a value, which corresponds to a rating symbol that represents ability of the company to fulfill an obligation as shown in FIG. 2. A rating firm assigns the rating symbol to, for example, the bond of the company according to the ability of the company to fulfill an obligation. For example, the rating AAA, which is the highest, corresponds to a value 26. In addition, the rating D, which is the lowest, corresponds to a value 1. From AAA to D, there is a relationship so that one credit score is decremented every time the rating lowers by one rank. Because the rating symbol assigned by the rating firm is discrete, the credit score corresponding to the rating symbol is also discrete. However, in the following explanation, the credit score is handled as a continuous value. There is a rating firm that uses the notation of the rating symbols as shown in FIG. 2, and there is another rating firm that uses another notation of the rating symbols. If any notation of the rating symbols is used, the correspondence between the notations is known. Therefore, this embodiment is applicable to notations other than shown in FIG. 2. Furthermore, the correspondence between AAA and 26 is an example, and other numeral values may be assigned to AAA. In that case, following formulas have to be changed as the numeral values are changed.

The estimated financial data, which is estimated by the financial data estimating unit 3 and corresponds to the input financial measures, is stored in the estimated financial data storage device 5. The estimated financial data, which is estimated by the financial data estimating unit 3, is input into the estimated financial data storage device 5, and the estimated financial data, which is calculated by other measures, may be input directly into the estimated financial data storage device 5. The estimated financial data storage device 5 is referred by the credit score calculating unit 7 and the bankruptcy probability calculating unit 9. The credit score calculating unit 7 and the bankruptcy probability calculating unit 9 cooperates by a selection unit 11. Namely, it is configured that the selection unit 11 selects calculation results of the credit scores, which are calculated by the credit score calculating unit 7 and correspond to the input financial measures, by a setting or selection input to the selection unit 11, and the bankruptcy probability is calculated for the estimated financial data, which is a source of the selected credit score.

In addition, the calculating result of the credit score calculating 7 is referred by an estimated rating computing unit 13. The estimated rating computing unit 13 computes a rating symbol and its probability from the credit score calculated by the credit score calculating unit 7. The bankruptcy probability calculated by the bankruptcy probability is data, which is a source of the pricing for various kinds of financial services, and is referred by the pricing calculating unit 15. The pricing calculating unit 15 performs the pricing calculation for financial services of kinds, which are set in advance or are input.

The calculation results of the credit score calculating unit 7, the bankruptcy probability calculating unit 9, the pricing calculating unit 15 and the estimated rating computing unit 13 are stored in a result storage device 17. An output unit 19 outputs necessary calculation results by referring to the result storage device 17.

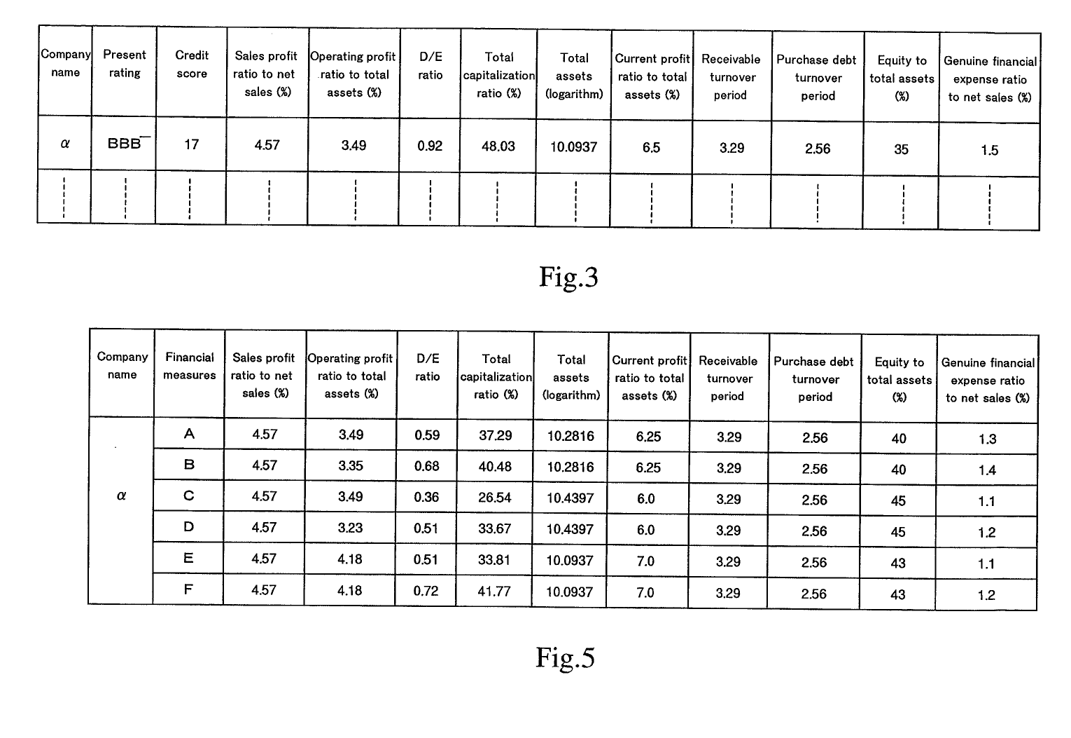

FIG. 3 shows an example of the present financial data of a company, which is stored in the present financial data storage device 1. In an example of FIG. 3, a present rating (rating symbol), a corresponding credit score, a sales profit ratio to net sales (%), an operating profit ratio to total assets (%), a D/E ratio, a total capitalization ratio (%), total assets (logarithm), a current profit ratio to total assets (%), a receivable turnover period, a purchase debt turnover period, an equity to total assets (%), and a genuine financial expense ratio to net sales (%) are stored for each company. The D/E ratio is calculated by (interest bearing debts/equity). The total capitalization ratio is calculated by ((interest bearing debts/(interest bearing debts+equity)). The current profit ratio to total assets is calculated by (current profit/total assets). The receivable turnover period is calculated by (average receivable of beginning and end of the fiscal/monthly average net sales). The purchase debt turnover period is calculated by (average purchase liabilities of beginning and end of the fiscal/monthly average sales costs). The equity to total assets is calculated by (equity/total assets). The financial data obtained by the calculation may be calculated at the necessary time by retrieving source data of the calculation. In addition, data other than the financial data shown in FIG. 3 may be stored in the present financial data storage device 1.

Because numeral values of the financial data and etc. shown in FIG. 3 and subsequent figures are based on numeral values of the specific company, they are changed not to specify that company in this embodiment. Thus, there are some cases in which numeral values with inconsistencies in relationships between financial data and calculation results by formulas described below are shown.

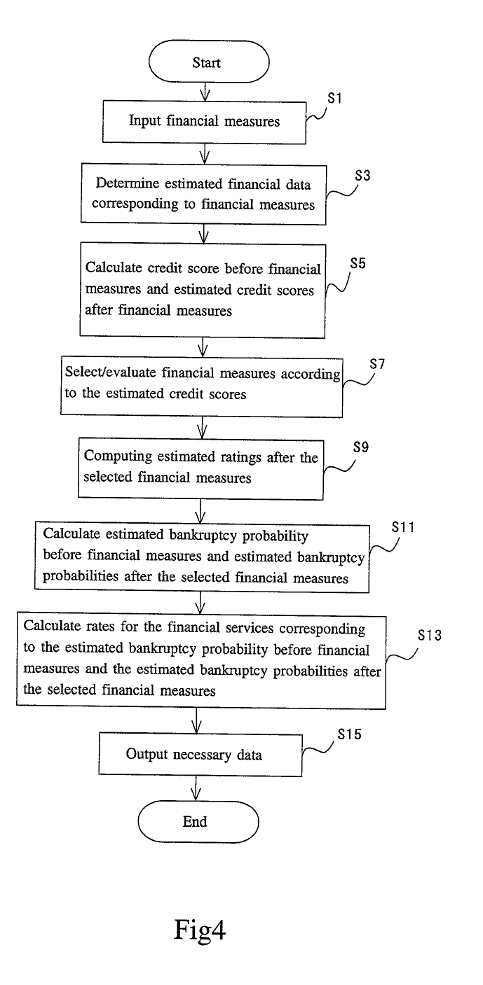

FIG. 4 shows a processing flow of the system for supporting provision of rating related service of this embodiment shown in FIG. 1. First, financial measures to improve the rating of the particular company are input to the financial data estimating unit 3 (step S1). The financial measures to improve the rating is, for example, to pay back interest bearing debts by funds gained by a capital increase, to pay back the interest bearing debts by funds gained by a structured finance, such as securitization of assets, such as under-utilized real states and sales credits, or to pay back the interest bearing debts by funds gained by selling stocks of consolidated subsidiary companies. In this embodiment, to calculate the estimated finance data, it is necessary to input data as to how much the capital is increased and how may debts are decreased, or what kind of assets and how many assets are sold and how may debts is paid back by the gained funds. As for the financial measures, there are cases in which all considerable financial measures are input, and in which financial measures the customer company desires or may desire are input.

Next, the financial data estimating unit 3 determines estimated financial data corresponding to each of the financial data based on a predetermined rule (step S3). For example, if the capital increase is selected as the financial measures, the operating profit ratio to total assets, the D/E ratio, the total capitalization ratio, the current profit ratio to total assets, the equity to total assets and so on, which are related to the equity, change because the equity is increased by the capital increase. In addition, if the capital increase is selected and the funds gained by the capital increase is used to pay back the interest bearing debts, the D/E ratio, the total capitalization ratio, the equity ratio and etc., which are related to the interest bearing debts change. If the structured finance, such as the securitization of assets, such as, the under-utilized real (unemployed) estates and sales credits, is selected, the financial data related to the assets changes because the assets are reduced. Furthermore, if the structured finance of the sales credits is selected, the receivable turnover ratio changes. In correspondence with these changes, the financial data estimating unit 3 calculates the estimated financial data after the financial measures. The calculation results are stored in the estimated financial data storage device 5.

If simple actions, such as the capital increase and the structured finance of the assets, are selected, impacts to the financial data are relatively clear. However, if more complex financial measures are supposed, it is possible to configure so that a financial scenario as to how such a complex financial measures effect to the financial data is prepared in advance, and the financial data estimating unit 3 performs calculations based on the financial scenario. In addition, as shown in FIG. 1, it is also possible that a user of the system for supporting provision of rating related service of this embodiment estimates, by himself or herself, the financial data after the selected financial measures are performed and he or she directly input the estimated financial data into the estimated financial data storage device 5.

FIG. 5 shows an example of data stored in the estimated financial data storage device 5. In FIG. 5, the estimated financial data of the kinds, which are shown in FIG. 3, is shown respectively corresponding to financial measures A to F, which will be proposed to company alpha. For instance, the financial measure A is a case in which the capital is increased by 5 billion Yen and the interest bearing debts are reduced by 5 billion Yen. The financial measure B is a case in which the capital is increased by 5 billion Yen and the interest bearing debts are reduced by 2.5 billon Yen. The financial measure C is a case in which the capital is increased by 10 billion Yen and the interest bearing debts are reduced by 10 billion Yen. The financial measure D is a case in which the capital is increased by 10 billion Yen and the interest bearing debts are reduced by 5 billion Yen. The financial measure E is a case in which the assets are securitized by 10 billion Yen and the interest bearing debts is reduced by 10 billion Yen. The financial measure F is a case in which the assets are securitized by 10 billion Yen and the interest bearing debts are reduced by 5 billion Yen. There is financial data which does not change by the financial measures and which does change by the financial measures. The estimated financial data storage device 5 may store estimated financial data other than kinds shown in FIG. 5.

Next, returning to FIG. 4, the credit score calculating unit 7 calculates a credit score s before the financial measures and a credit score s′ after the financial measures by the present financial data stored in the present financial data storage device 1, the estimated financial data stored in the estimated financial data storage device 5 and an equation explained below (step S5). In this embodiment, the equation used by the credit score calculating unit 7 is as follows:

s=3.77*(the sales profit ratio to net sales)+7.85*(current profit ratio to total assets)−0.129*(D/E ratio)−3.17*(total capitalization ratio)+1.52*(total assets(logarithm))+(industry group factor) (a)

The industry group factor is as follows:

Mining industry: 3.26 Construction industry: 2.59 Food industry: 3.56

Textile industry: 2.52 Pulp and paper industry: 3.28

Chemistry industry: 3.60

Medicine industry: 2.56 Oil and coal goods industry: 2.51

Rubber goods industry: 2.44 Glass, clay stone goods industry: 3.23

Steal industry: 2.72 non-steal metal industry: 3.00

Metal goods industry: 2.78

Machine industry: 3.02 Electric device industry: 3.30

Transportation machine industry: 3.22

Precision machinery industry: 3.38

Miscellaneous goods industry: 3.09 Electric, and gas industry: 8.27

Land transportation industry: 4.47

Marine transportation industry: 4.51

Aero transportation industry: 2.27

Warehouse and transportation related industry: 4.43

Communication industry: 3.71

Wholesale trade: 3.20 Retail trade: 2.55

Real property industry: 3.47

Service industry: 3.02

The equation (a) is an equation, which corresponds to a particular rating firm. Therefore, an equation, which corresponds to other rating firm, is in other format. In addition, the equation (a) is determined by correlations (for example, regression analysis or multiple regression analysis) between the financial data at a certain time and the ratings, and changes as the time elapses. The financial data used in the equation (a) changes and coefficients can be also changed. In addition, there is a case in which it is not suitable to apply the equation (a) to companies, which have extremely bad or good financial data (that is, unusual data). The credit score calculating unit 7 uses the equation (a) and the estimated financial data stored in the estimated financial data, and calculates an estimated credit score corresponding to each financial measure, and stores the calculation results into a storage device, such as a main memory in a computer, for example. In addition, the credit score calculating unit 7 uses the equation (a) and the present financial data stored in the present financial data storage device 5, and calculates the present credit scores, and stores the calculation results into the storage device. With this, it becomes possible to know an improved degree of the rating (credit score) if each financial measure is performed. Namely, the improved degree is a difference between the estimated credit score and the present credit score. The credit score calculating unit 7 may calculate the difference between the estimated credit score and the present credit score.

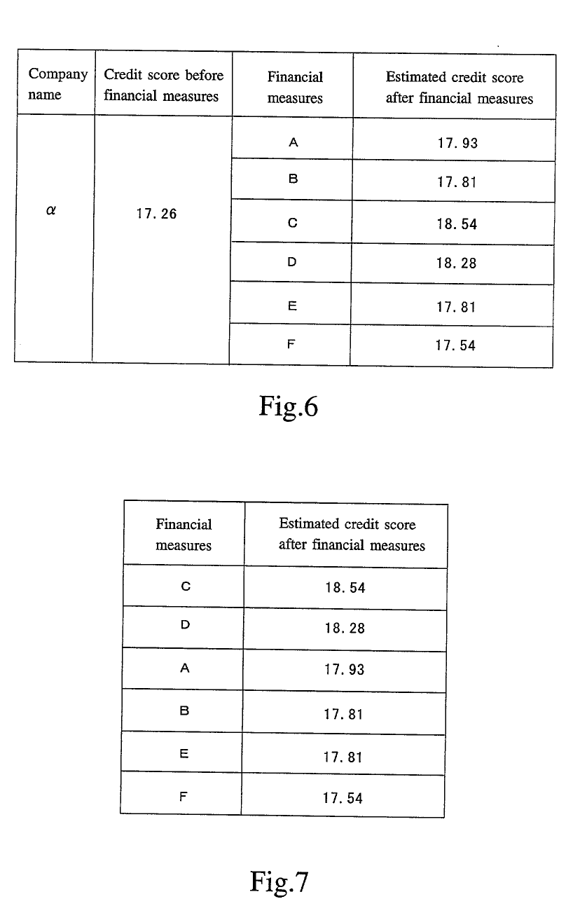

FIG. 6 shows an example of calculation results of the credit score calculating unit 7. FIG. 6 shows, as to company alpha, a credit score before the financial measures and the estimated credit scores after the financial measures respectively corresponding to financial measures A to F. In this example, if the financial measures are arranged in order of highly effective financial measures, the order is C, D, A, B, E, F.

Next, returning to FIG. 4, the selection unit 11 selects and evaluates financial measures based on the estimated credit score and so on calculated by the credit score calculating unit 7 (step S7). For example, the selection unit 11 selects financial measures that satisfy a predetermined condition set by a user in advance. The predetermined condition is a condition, for example, in which a difference between the present credit score and the estimated credit score is equal to or higher than 0.5, or a condition in which the financial measures are within three higher ranking in order of the estimated credit score. In addition, it is possible to configure the selection unit 11 so as to sort the financial measures in order of higher credit score, for example, as shown in FIG. 7, and to present the sorting result to a user of the system for supporting provision of rating related service in this embodiment to make the user select. The selection unit 11 may selects all the financial measures.

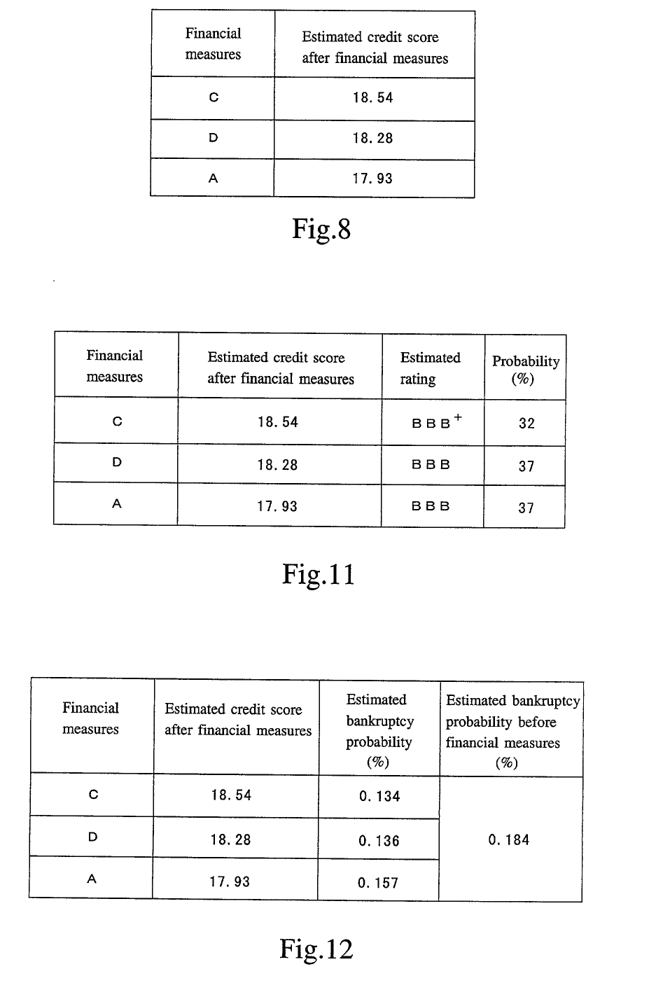

In this embodiment, it is supposed that the selection unit 11 selects three higher-ranking financial measures in order of the estimated credit score. Namely, as shown in FIG. 8, financial measures C, D, and A are selected. The selection results of the selection unit 11 are output to the bankruptcy probability calculating unit 9.

Next, the estimated rating computing unit 13 computes the estimated rating after the financial measures selected by the selection unit 11, and stores it into the storage device, such as a main memory (step S9). More specifically, the estimated rating computing unit 13 computes the estimated rating, which has the highest probability, from the estimated credit score, and stores it into the storage device.

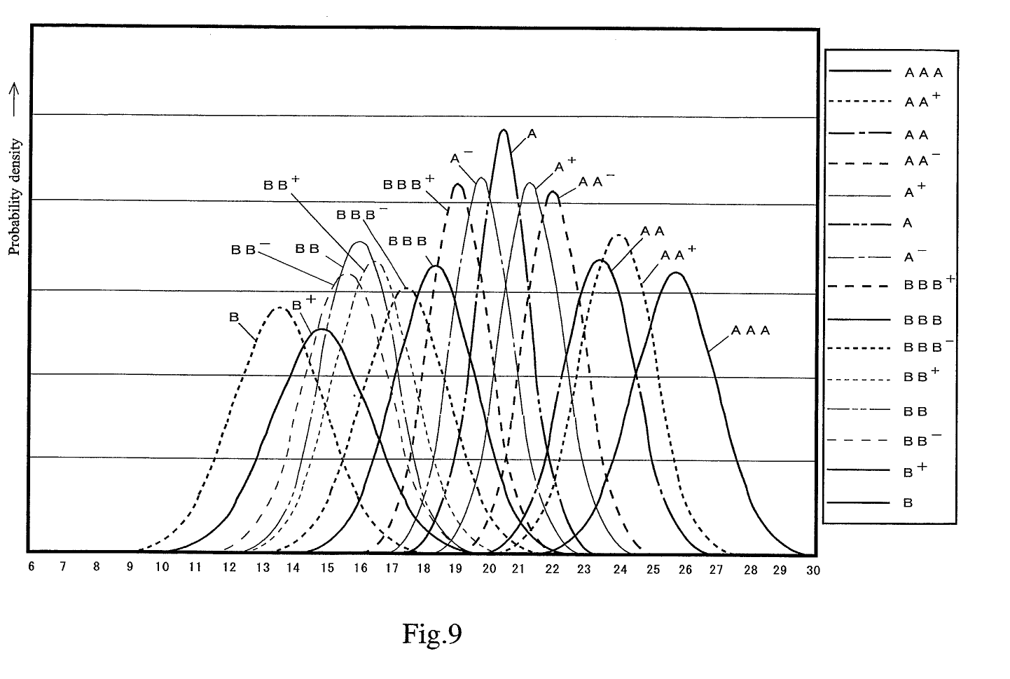

As shown in FIG. 9, even if rating AAA is assigned, its credit score that is calculated by the equation (a) is not constant and has a certain distribution. That is, even if the bond of the company has 26 points, which is the central store in the distribution for AAA, AA+ may be assigned or AA (flat) may be assigned. Therefore, in this embodiment, the estimated rating computing unit 13 computes rating (symbol), which has the highest probability, based on the estimated credit scores calculated by the credit score calculating unit 7. Here, it is supposed that the distribution is a normal distribution.

As a premise, the average value of the credit scores and the standard deviation are calculated for each rating. Then, the estimated credit score x is substituted together with the average value xₐ of the credit scores and the standard deviation into a probability density function f(x). The probability density function f(x) is expressed as follows:

$$f ( x ) = \frac{1}{\sqrt{2 π} σ} {ⅇ}^{- \frac{1}{2} {( \frac{x - {x}_{o}}{σ} )}^{2}} \qquad ( b )$$

Next, a ratio of a probability density f(x) for a certain rating to total value of probability densities f(x) for all ratings is calculated as the probability for that certain rating. Then, probabilities for all ratings are calculated.

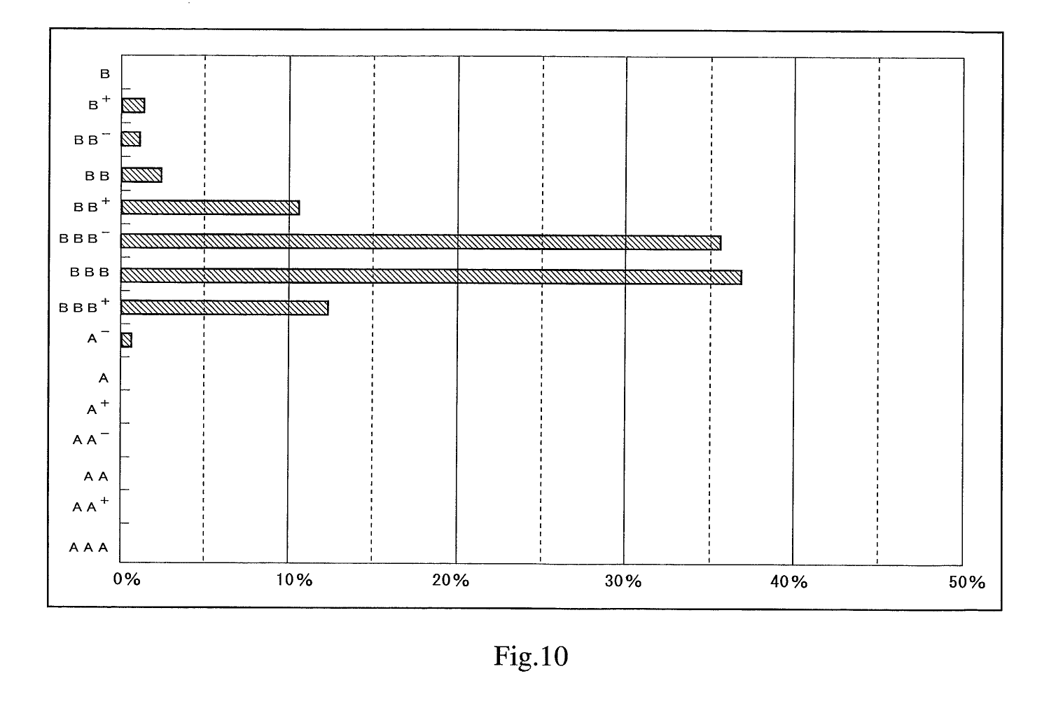

By such calculations, if the estimated credit score is 17.8, a graph in FIG. 10 can be drawn. In case of 17.8, the rating that has the highest probability is BBB (flat), subsequently BBB−, BBB+, . . . . In this embodiment, BBB (flat), which has the highest probability, is stored for the estimated credit score 17.8, and its probability (about 37%) is also stored.

The estimated rating computing unit 13 performs above described processing for all estimated credit scores corresponding to financial measures selected by the selection unit 11. Namely, as shown in FIG. 11, the estimated rating computing unit 13 computes for each selected financial measure, the estimated rating and its probability. The calculation results until this are stored in the result storage unit 17.

Next, returning to FIG. 4, the bankruptcy probability calculating unit 9 calculates the estimated bankruptcy probabilities by using the following equation (logit model) from the present financial data before the financial measures and the estimated financial data after the financial measures selected by the selection unit 11, and stores the calculation results into the storage device, such as the main memory (step S11). The equation used by the bankruptcy probability calculating unit 9 is as follows:

P=1/(1+e^{z}) (c)

z=3.81+0.024*(current profit ratio to net sales)−0.072*(receivable turnover period)−0.16*(purchase debt turnover period)+0.021*(equity to total assets)−0.085*(genuine financial expense ratio to net sales)+0.18*(total assets (logarithm)) (d)

The equation (c) is for the manufacturing industry. The equation (d) may be changed for other industries. The calculation by the equations (c) and (d) is performed using the estimated financial data corresponding to each financial measure. In addition, the calculation by the equations (c) and (d) is performed using the present financial data. Then, for example, results as shown in FIG. 12 are obtained and stored into the storage device. In FIG. 12, the estimated bankruptcy probabilities after the financial measures are shown for each of the financial measures C, D, and A, which are selected by the selection unit 11. In addition, the present bankruptcy probability (before the financial measures) of company alpha is also shown. The bankruptcy probability calculating unit 9 may calculate, as an improved degree of the bankruptcy probability corresponding to each financial measure, a difference between the estimated bankruptcy probability after the financial measures and the present bankruptcy probability and may store the difference into the storage device.

Then, the pricing calculating unit 15 calculates a rate for each kind of financial services, which corresponds to the calculation results of the bankruptcy probability calculating unit 9, that is, the estimated bankruptcy probability before the financial measures and the estimated bankruptcy probability after the selected financial measures and stores the rate into the storage device (step S13). It is possible to perform settings of the financial services for the pricing calculating unit 15 in advance, or to input each time, information concerning the financial services by users of the system for supporting provision of rating related service of this embodiment. The financial service may be, for example, a guarantee for paying interest for debts, financing or other services.

There are various variations for the equation for calculating a rate for the financial service from the estimated bankruptcy probability. For example, the financing rate rₐ is calculated by the following equation.

rₐ=(interest rate without risk)+(estimated bankruptcy probability)+(consideration for risk taking) (e)

For example, in case of a premium rate r_{b} for the guarantee, it is calculated by the following formula.

r_{b}≧(estimated bankruptcy probability)*(consideration for the guarantee by the insurance company) (f)

If the insurance company has, for example, a rating AAA and the insurance company guarantees the debts, the debts can get the rating AAA. Therefore, if the guarantee by the insurance company with higher rating is obtained, a fund-raising cost lowers more. As for the premium rate for the guarantee, since there are many cases in which other factors are taken into consideration, the symbol “≧” is used here.

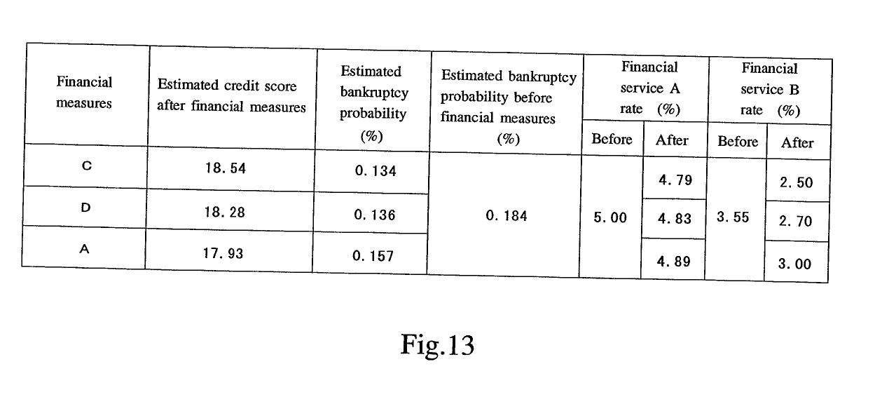

FIG. 13 shows examples of calculation results by the pricing calculating unit 15. In FIG. 13, for each of the financial measures C, D and A, the estimated bankruptcy probabilities after the financial measures and rates for financial service A (for example, financing) and financial service B (for example, guarantee) are shown. In addition, the pricing calculating unit 15 may calculate as data representing an improved degree of the rate for the financial service, a difference between a rate for a financial service after the financial measures and a present rate and may store the difference into the storage device.

By performing processing as shown in FIG. 4, the present credit scores, the present estimated bankruptcy probabilities, estimated credit scores after the financial measures selected by the selection unit 11, the estimated ratings and their probabilities, the estimated bankruptcy probabilities, and the rates for the financial service are stored into the result storage unit 17.

The output unit 9 reads out data for presenting to the customer company in data stored in the result storage unit 17 according to instructions by the user of the system for supporting provision of rating related service of this embodiment and outputs it to an output device, such as a display device, and printer (step S15).

The user can enhance the added value by presenting to the customer company, the present rating (symbol) and the estimated bankruptcy probability as a credit risk amount, the estimated rating and the estimated bankruptcy probability after the financial measures, pricing information of the financial service after and before the financial measures for each financial measure selected by the selection unit 11 and by adding further consultation information.

The aforementioned embodiment is one example and various variations are possible. For example, the functional block diagram shown in FIG. 1 is an example, and one functional block in FIG. 1 may be divided to a plurality of functional blocks and a plurality of blocks in FIG. 1 may be integrated into one block. Furthermore, the processing flow shown in FIG. 4 is one example, and for example, step S9 and step S11 may be exchanged in order and may be executed in parallel. Step S11 and step S13 may also be exchanged in order and may be executed in parallel. If there is no selection unit 11 or the selection unit 11 selects all of the financial measures, it is possible to make the system execute step S5 to S9 and step S11 and S13 in parallel.

In the above described embodiment, the estimated bankruptcy probability is calculated by the formula (c) and (d). However, it is possible to calculate z by the formula (d) and to use it in the pricing calculating unit 15.

Furthermore, it is possible to calculate an index representing other credit risk and to use it.

In addition, in the above described embodiment, the rate for the financial service is not a direct function of the estimated credit score, but may be a direct function. The financial service may be called as a financial instrument. In addition, the credit score may be called as a rating point or point value. As described above, numeral values of the financial data and etc. shown in figures are changed not to specify the particular company. Thus, there are some cases in which numeral values with inconsistencies in relationships between financial data and calculation results by formulas described below are shown.

As described above, the present invention can provide technology for clearly expressing effects of the financial measures to improve the rating to the customer company.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A system for supporting provision of rating related service, comprising:
means for calculating an estimated rating point value corresponding to a financial state changing measure applicable to a particular company by using estimated financial data after said financial state changing measure applicable to said particular company is performed and a predetermined rating point value formula;
means for calculating numeral data that corresponds to said estimated rating point value and is associated with credit risk of said particular company by using said estimated financial data after said financial state changing measure is performed; and
means for outputting information concerning said estimated rating point value calculated and the calculated numeral data.

2. The system set forth in claim 1, further comprising,
means for stochastically estimating a rating from said estimated rating point value, and
wherein said information concerning said estimated rating point value calculated is the stochastically estimated rating.

3. The system set forth in claim 1, further comprising,
means for calculating a rating point value corresponding to a present financial state of said particular company by using financial data that represents said present financial state of said particular company and said predetermined rating point value formula, and
wherein said means for outputting outputs said rating point value corresponding to said present financial state of said particular company or an improved point value of said estimated rating point value from said rating point value corresponding to said present financial state.

4. The system set forth in claim 1, further comprising,
means for computing an estimated rating corresponding to said estimated rating point value and information concerning probability of said estimated rating, and
wherein said means for outputting outputs said estimated rating corresponding to said estimated rating point value and said information concerning said probability of said estimated rating.

5. The system set forth in claim 1, further comprising,
means for calculating numeral data associated with present credit risk of said particular company by using financial data that represents a present financial state of said particular company, and
wherein said means for outputting outputs said numeral data associated with said present credit risk of said particular company or an improved degree of said numeral data that corresponds to said estimated rating point value and is associated with said credit risk from said numeral data associated with said present credit risk.

6. The system set forth in claim 1, wherein said means for calculating said numeral data associated with said estimated credit risk calculates bankruptcy probability of said particular company by using said estimated financial data after said financial state changing measure is performed and a predetermined bankruptcy probability formula.

7. The system set forth in claim 6, wherein said means for calculating said numeral data associated with said estimated credit risk calculates numeral data concerning costs of one or a plurality of financial services applicable to said particular company, said numeral data concerning costs corresponding to said data concerning said bankruptcy probability of said particular company.

8. The system set forth in claim 1, wherein said means for calculating said estimated rating point value calculates estimated rating point values respectively corresponding to a plurality of financial state changing measures applicable to said particular company by using a plurality of estimated financial data after said plurality of financial state changing measures applicable to said particular company are performed and said predetermined rating point value formula, and wherein said means for calculating said numeral data associated with said estimated credit risk calculates numeral data that is associated with said estimated credit risk of said particular company and corresponds to a selected estimated rating point value of said plurality of said estimated rating point values calculated by said means for calculating said estimated rating point value.

9. A method for supporting provision of rating related service, said method comprising the steps of:
calculating an estimated rating point value corresponding to a financial state changing measure applicable to a particular company by using estimated financial data after said financial state changing measure applicable to said particular company is performed and a predetermined rating point value formula;
calculating numeral data that corresponds to said estimated rating point value and is associated with credit risk of said particular company by using said estimated financial data after said financial state changing measure is performed; and
outputting information concerning said estimated rating point value calculated and the calculated numeral data.

10. The method set forth in claim 9, further comprising a step of:
stochastically estimating a rating from said estimated rating point value, and
wherein said information concerning said estimated rating point value calculated is the stochastically estimated rating.

11. The method set forth in claim 9, further comprising a step of:
calculating a rating point value corresponding to a present financial state of said particular company by using financial data that represents said present financial state of said particular company and said predetermined rating point value formula, and
wherein said outputting step includes a step of outputting said rating point value corresponding to said present financial state of said particular company or an improved point value of said estimated rating point value from said rating point value corresponding to said present financial state.

12. The method set forth in claim 9, further comprising a step of:
computing an estimated rating corresponding to said estimated rating point value and information concerning probability of said estimated rating, and
wherein said outputting step includes a step of outputting said estimated rating corresponding to said estimated rating point value and said information concerning said probability of said estimated rating.

13. The method set forth in claim 9, further comprising a step of:
calculating numeral data associated with present credit risk of said particular company by using financial data that represents a present financial state of said particular company, and
wherein said outputting step includes a step of outputting said numeral data associated with said present credit risk of said particular company or an improved degree of said numeral data that corresponds to said estimated rating point value and is associated with said credit risk from said numeral data associated with said present credit risk.

14. The method set forth in claim 9, wherein said step of calculating said numeral data associated with said estimated credit risk includes a step of calculating bankruptcy probability of said particular company by using said estimated financial data after said financial state changing measure is performed and a predetermined bankruptcy probability formula.

15. The method set forth in claim 14, wherein said step of calculating said numeral data associated with said estimated credit risk calculates numeral data concerning costs of one or a plurality of financial services applicable to said particular company, said numeral data concerning costs corresponding to said data concerning said bankruptcy probability of said particular company.

16. A storage medium for storing a program for causing a computer to support provision of rating related service, said program comprising the steps of:
calculating an estimated rating point value corresponding to a financial state changing measure applicable to a particular company by using estimated financial data after said financial state changing measure applicable to said particular company is performed and a predetermined rating point value formula;
calculating numeral data that corresponds to said estimated rating point value and is associated with credit risk of said particular company by using said estimated financial data after said financial state changing measure is performed; and
outputting information concerning said estimated rating point value calculated and the calculated numeral data.

17. The storage medium set forth in claim 16, said program further comprising a step of:
stochastically estimating a rating from said estimated rating point value, and
wherein said information concerning said estimated rating point value calculated is the stochastically estimated rating.

18. The storage medium set forth in claim 16, said program further comprising a step of:
computing an estimated rating corresponding to said estimated rating point value and information concerning probability of said estimated rating, and
wherein said outputting step includes a step of outputting said estimated rating corresponding to said estimated rating point value and said information concerning said probability of said estimated rating.

19. The storage medium set forth in claim 16, wherein said step of calculating said numeral data associated with said estimated credit risk includes a step of calculating bankruptcy probability of said particular company by using said estimated financial data after said financial state changing measure is performed and a predetermined bankruptcy probability formula.

20. The storage medium set forth in claim 19, wherein said step of calculating said numeral data associated with said estimated credit risk includes a step of calculating numeral data concerning costs of one or a plurality of financial services applicable to said particular company, said numeral data concerning costs corresponding to said data concerning said bankruptcy probability of said particular company.
